(19) United States
(12) Patent Application Publication
(10) Pub. No.: US 2007/0284449 A1
(43) Pub. Date: Dec. 13, 2007

(54) Personal shopping aid system

(76) Inventor: Eric Hung-Ying Yuen, Tuen Mun (HK)

Correspondence Address: YUEN, ERIC HUNG-YING;Flat F, 5/Fl., Block 6, Botania Villa, 138 Fuk Hang Tsuen Road, Tuen Mun, NT, omitted

(21) Appl. No.: 11/789,069

(22) Filed: Apr. 24, 2007

Related U.S. Application Data
(60) Provisional application No. 60/812,571, filed on Jun. 12, 2006.

(51) Int. Cl. G06K 7/10

(52) U.S. Cl. 235/462.45

(57) ABSTRACT

A self contained micro controller based personal barcode shopping aid system that includes a barcode reader, a manual input device, a display device, a printing device, and build-in database to input, display, store and output personal shopping list using barcodes. This system also stores and organizes coupons barcodes. The system will remind user when there is a possible match between items in the shopping list and cost saving coupons.

### U.S. PATENT DOCUMENTS

| | | |
|---|---|---|
| 5424524 | June, 1995 | Ruppert, et al. |
| 5640002 | June, 1997 | Ruppert, et al. |
| 6644687 | August, 2002 | Schinella, et al. |
| 6595417 | July, 2003 | O'Hagan, et al. |
| 6678685 | January, 2004 | McGill, et al. |
| 6851611 | February, 2005 | Shaw-Sinclair, et al. |
| 7010501 | March, 2006 | Roslak, et al. |

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Most households make their grocery shopping once or twice per week. To avoid leaving out needed items, each household member will make up a shopping list. These lists will be consolidated before the trip to grocery stores. This task can be daunting for the elderly and young ones as they may have trouble in remembering what items to buy or in writing due to physical limitation such as seeing impaired or arthritis.

A common annoyance of using coupons in shopping is to find out that coupons have expired or being left behind at home.

Due to the popularity of personal computers (PCs) and Personal Data Assistants (PDAs), there are add-on PC and PDA products scan barcodes and organize product database using software running inside the personal computers. The resulting list can be printed out using the PC peripheral printer. However, the cost of the add-on barcode scanner, the cost of the software, and the PC or PDA is not dedicated to this task making the barcode shopping aid systems using PC or PDA have not gain popularity. Due to the dependency on PCs or PDAs, certain computer skills, on both the hardware and software implementation, are needed. A self-contained device such as the present invention does not require any computer knowledge to set up or to operate the device.

A patent search has revealed a product, U.S. Pat. No. 6,851,611, designed to manage personal inventory. The user carries this device with the personal inventory stored inside during shopping. Another product, U.S. Pat. No. 6,644,697, integrated the shopping list and coupon folder to form a single product item. The task of actually writing down the list is left to the users. Other inventions, U.S. Pat. No. 5,424,524, U.S. Pat. No. 7,010,501, U.S. Pat. No. 6,595,417, require user to connect the invention with a host computer which is connected to a shopping establishment through a computer network.

The present invention differs significantly in both the hardware and software implementation. The present invention integrates a printer output device to give easy to carry written record of the shopping list. With the apparatus designed to be used at home and preferably inside kitchen, the use of this apparatus is not limited to a single member of the household or a specific group of shopping establishments. The embedded firmware accommodates coupon barcodes and cross-references the shopping lists with coupons. The embedded firmware also manages the coupons based on the expiration dates of the coupons. The embedded firmware also remind user of important shopping dates.

This invention combines several hardware technologies such as a barcode reader similar to the CueCat, a thermal printer commonly found in commercial point-of-sale machines and novel software implementation to produce an innovative self-contained product to address the above issues. This invention is the first of its kind in the barcode scanner and personal shopping aid product categories.

### SUMMARY OF THE INVENTION

This invention is an apparatus to aid consumers to compile shopping lists prior to their shopping trips and to organize the cost saving coupons based on the expiration date of the coupons and the issued brand of the coupons.

This apparatus is a self-contained integrated personal barcode scanning device which comprises a detachable power converter, a dedicated barcode reader, a microcontroller and associated control software, a flash memory, a display, a thermal printer, a keypad input, LED indicator lights, control button, and buzzer.

This apparatus helps the users to organize cost saving coupons. The users can scan the barcode on the coupon. The microcontroller recognizes that the barcode being scanned is for coupon. The microcontroller prompts the user to enter the expiration date of the coupon and then stores the information in the dedicated database. This apparatus deletes the expired coupons from the coupon database. A list of current coupons can be printed out by pushing a dedicated button.

Whenever there is an item needs to be purchased, the user uses the build-in barcode scanner to scan the barcode on the item or the barcode printed on the packaging. This apparatus translates the light and dark patterns of the barcode into human readable barcode numbers. The microcontroller displays the barcode number on the display. The apparatus then search within the build-in database and then the user defined database to find a match between the barcode and a description of the barcode. When a match is found and the user acknowledges the resulting search, the item is time and date stamped and added to the current shopping list. If a match cannot be found, this apparatus prompts the user to use the keypad to manually enter the descriptions of the item being scanned and add the item to the user defined database as well as the current shopping list. To print the shopping list, the user only needs to push a dedicated button and the shopping list is printed out by the build-in thermal printer. The microcontroller marks the items when there are coupons matching the manufacturers of the items within the shopping list. This list will be achieved into the memory and the current shopping list memory space is cleared for new items. The previously achieved shopping lists can also be printed out by pushing another dedicated button.

### BRIEF DESCRIPTION OF THE DRAWINGS

FIG. 1 is a perspective view of one possible package of a self-contained embodiment of the present invention.

FIG. 2 is a functional block diagram showing the elements comprising the embodiment depicted in FIG. 1.

FIG. 3 is a block diagram showing one possible partition organization of the data memory.

FIG. 4 is a flow chart of the high level user interface that could be used in the present invention.

FIG. 5 is a detail flow chart of the Print Shopping List hot-key function.

FIG. 6 is a detail flow chart of the Print Previous List hot-key function.

FIG. 7 is a detail flow chart of the Print Coupon List hot-key function.

FIG. 8 is a detail flow chart for two manual input functions.

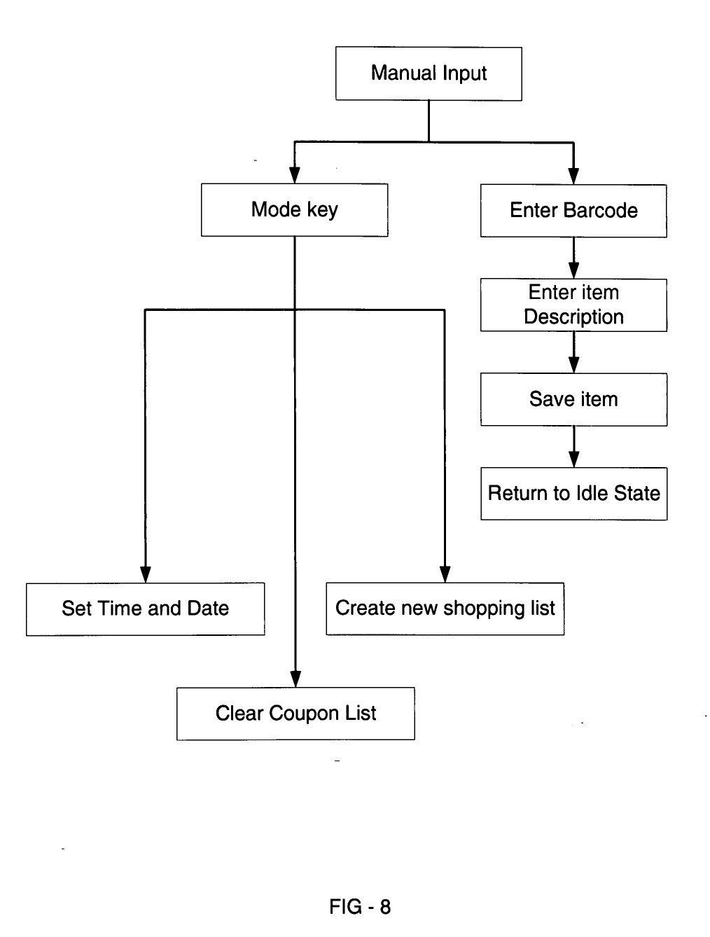

FIG. 9 is a flow chart for scanning barcode.

### DETAILED DESCRIPTION OF THE PREFERRED EMBODIMENT

Preferred embodiments of the present invention will be explained with reference to the accompany drawings.

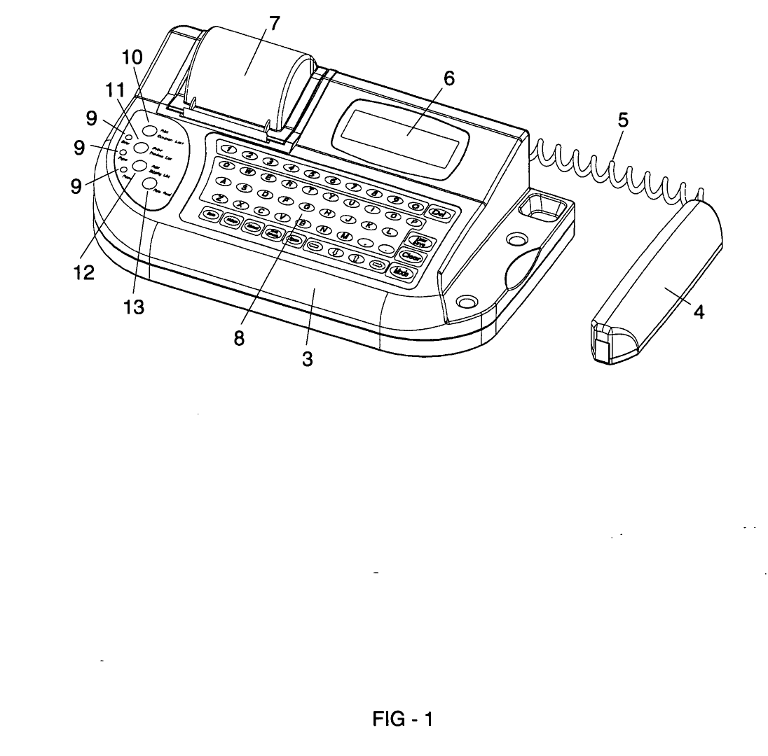

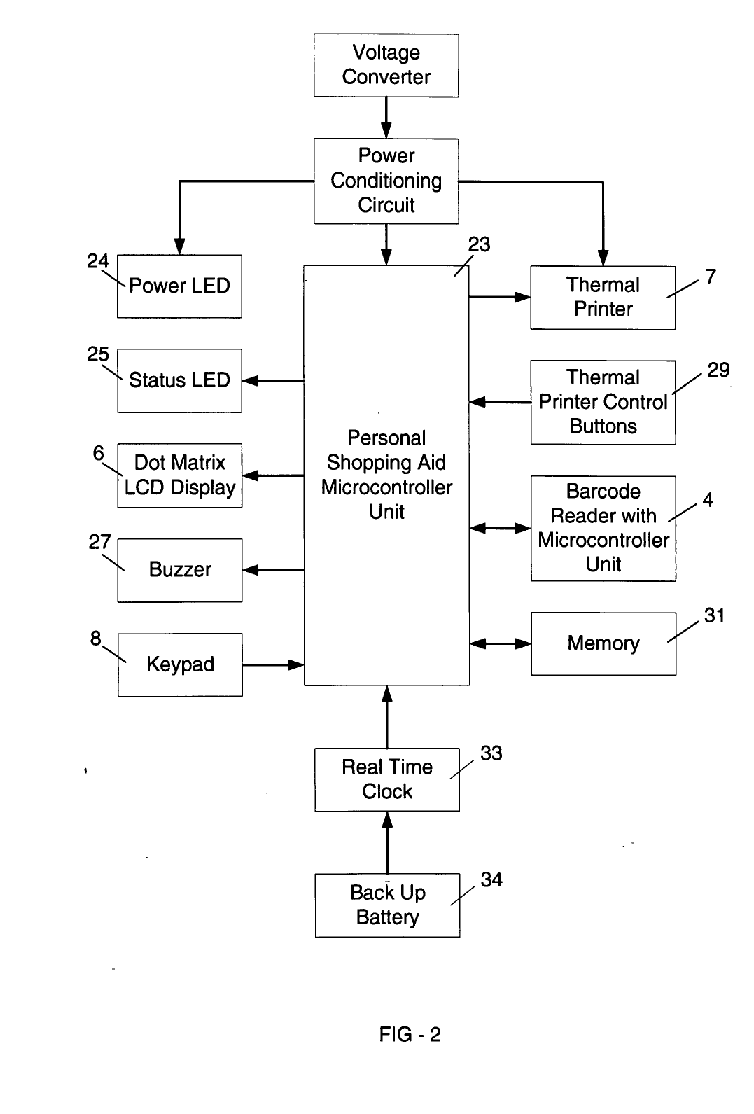

As shown in FIG. 1 and FIG. 2, a self-contained personal shopping aid system of the present invention can be embodied all in one device. This simplest of embodiments have a barcode reader 4, a display 6, a means for manual data entry 8, a thermal printer 7, at least one built-in database stored in data memory 31, and digital data storing and processing capabilities on a printed circuit board.

The type of barcode used in the present invention is not limited to the UPC code. Any other standard barcode formats such as ISBN, ISSN or Code 128 decoding firmware can be integrated into the existing apparatus. Without lost of generalization, UPC code is used herein to describe the function and operation of the present invention.

The data stored contain not only the numeric representation of the barcode. Each item stored in the database, whether the build-in barcode database 40, customer barcode database 41, coupon barcode database 42, or the shopping list database 43, 43 also contains descriptions of the item. Example of descriptions can be the name of the item, brand of the item, title of the item, size of the item, unit of measure of the size of the item or package method of the item.

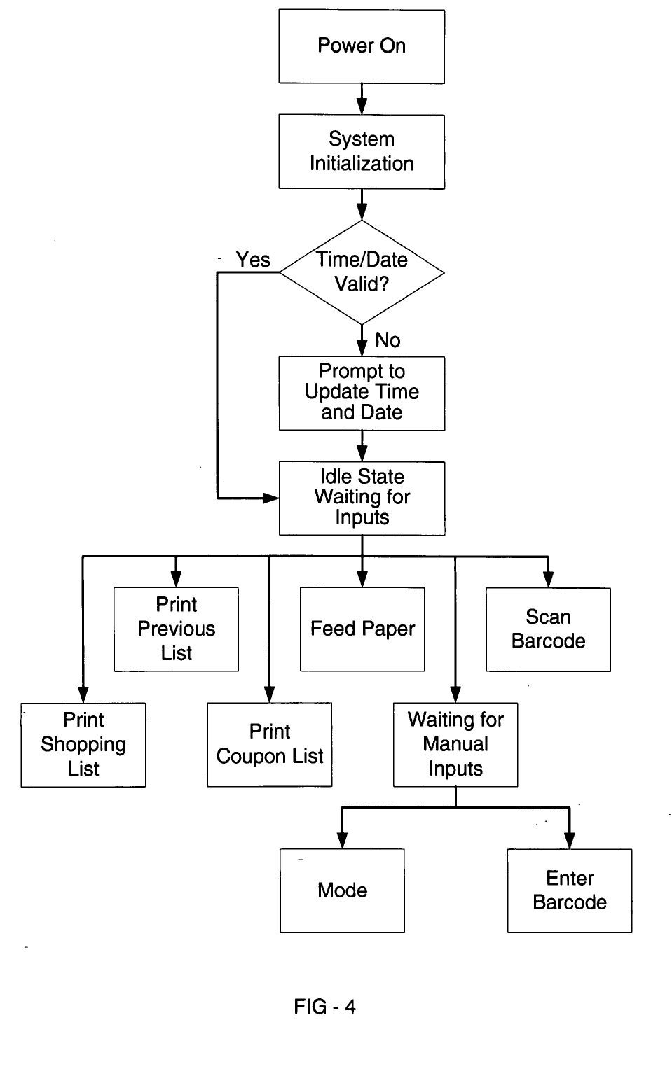

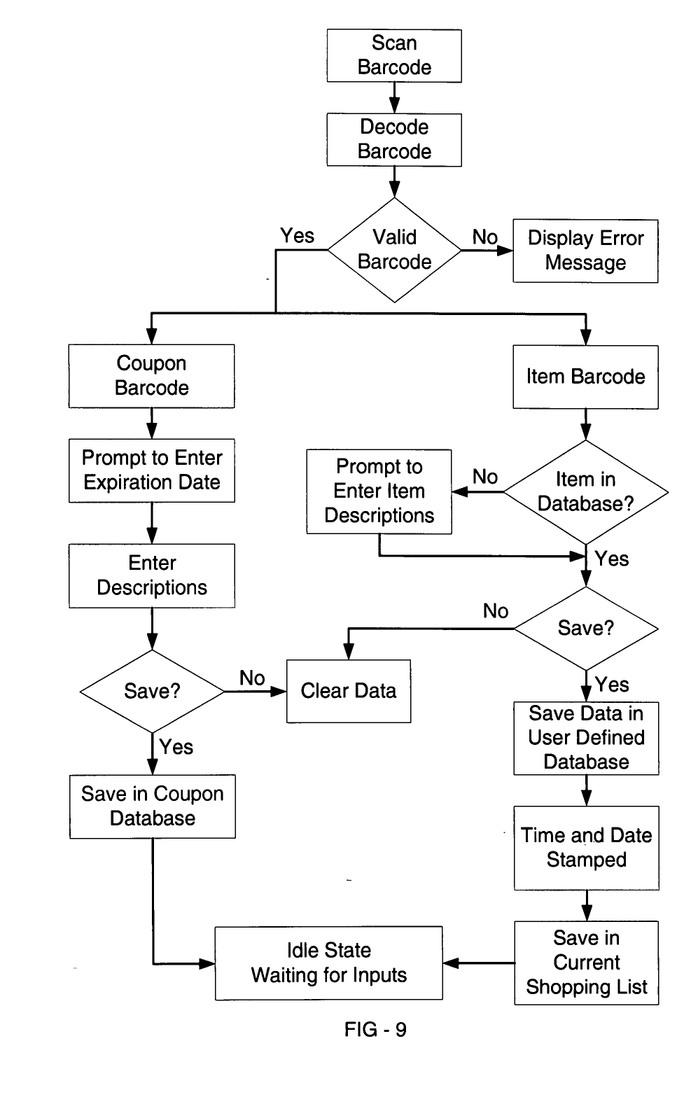

Referring to FIG. 1 and FIG. 4, when power is supplied to the apparatus for the first time or after power is disconnected from the apparatus for prolong period of time, the microcontroller 23 will prompt the user to update the time and the date via the dot matrix LCD display 6 using the flow chart in FIG. 4. After the time and date information is updated, the apparatus is ready and remain in the idle state. When user needs to add an item to the shopping list, the user uses the barcode reader 4 to sweep the light emitting port of the barcode reader across the barcode on the item, the barcode reader will decode the light and dark patterns and transmits the encrypted data to the base unit 3 microcontroller via the flexible cable 5. When a barcode is decoded successfully, an audible sound is issued to the buzzer 27. Based on the first digit of the UPC code, the microcontroller 23 determines the item being scanned is a product or coupon. One possible implementation algorithm is shown in a software flowchart in FIG. 9.

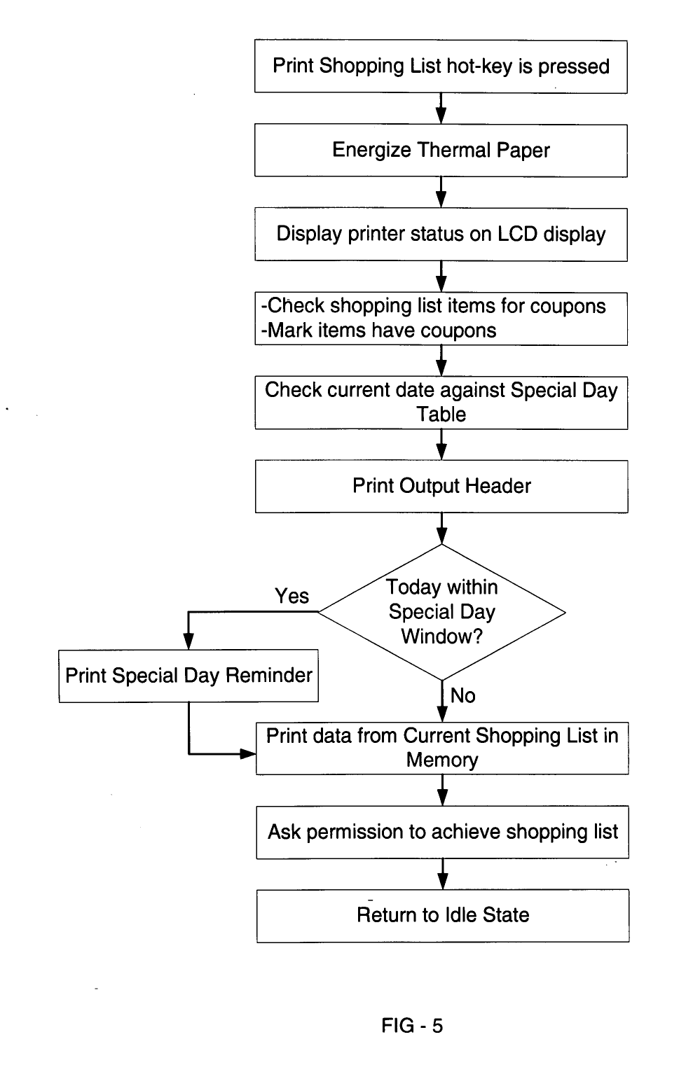

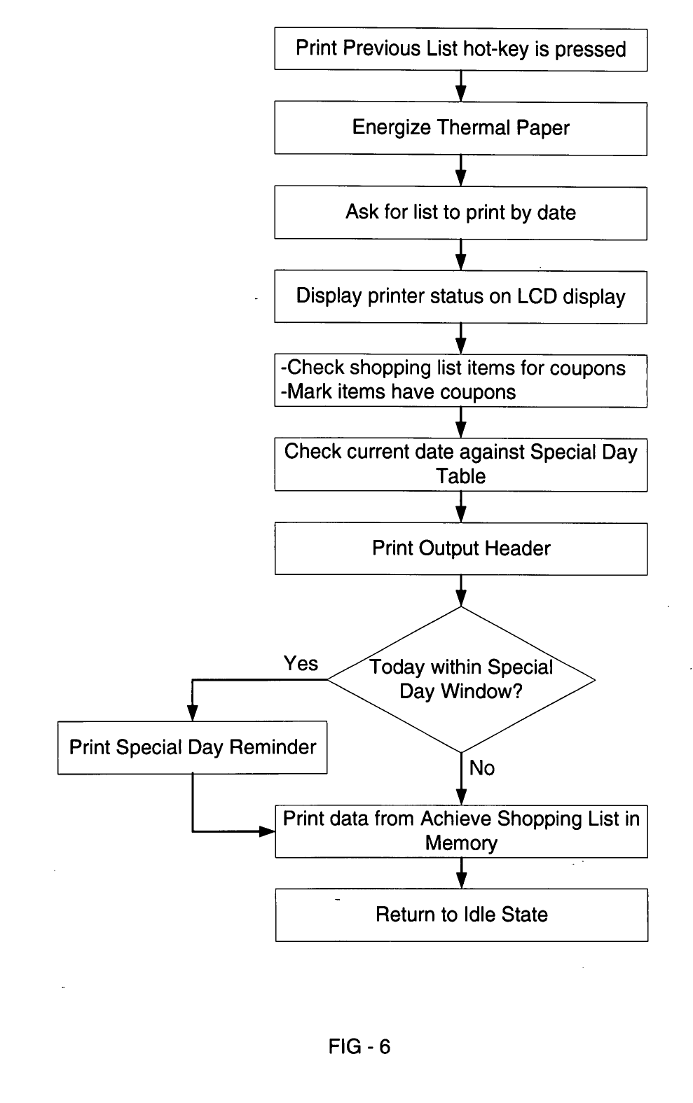

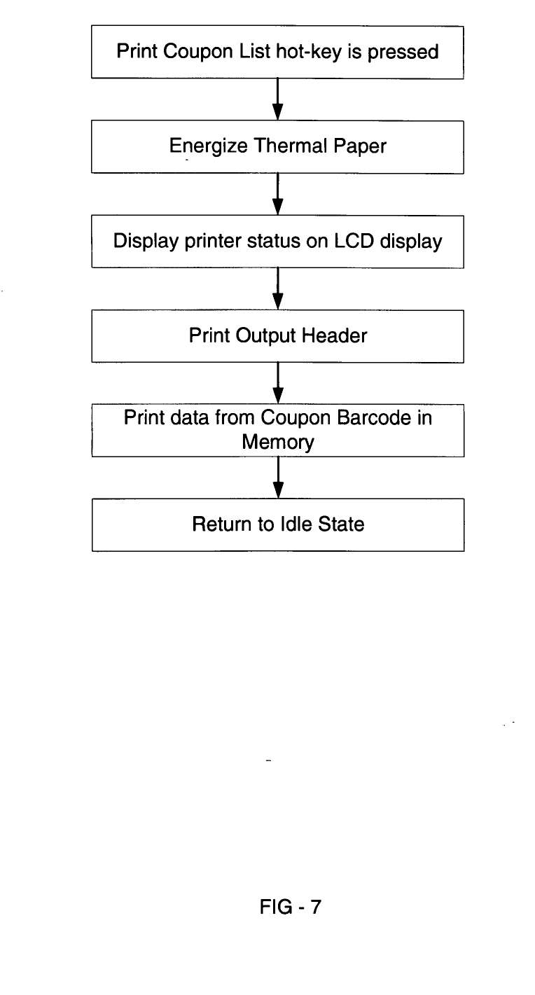

FIG. 2 is a functional block diagram of the present invention. FIG. 4 is a possible high-level software flow chart of the present invention. Although one or more functional blocks can be omitted, all these functional blocks work together in a single device comprises a user friendly and self-contained invention. A status indicator light group 9 comprises a power LED 24, and a status LED 25. A printer control block 29 consists of 4 switches which control the printer devise directly. The switches are referred to as hot-keys and they give user quick access to the most often used printer functions by a single key stroke and without the need to scroll through the menu of the software user interface. A paper feed button 10 turns on the thermal printer motor to facilitate the paper insertion process and to advance the printer paper. A print shopping list button 13 initiates the MCU to execute print current shopping list instructions base on the flow chart in FIG. 5. After the current list is printed out, the list is achieved in the specific achieve shopping lists area 44 of the flash memory 31 and the current shopping list memory space 43 is cleared. A print previous shopping list button 12 initiates the MCU to execute print previous shopping lists instructions base on the flow chart in FIG. 6. Through the dot matrix LCD display 6, the MCU 23 prompts the user to select which of the previous shopping list to print from. A print coupon list button 11 initiates the MCU 23 to execute print coupon list instructions base on the flow chart in FIG. 7.

The software flow chart of FIG. 9 is used whether the barcode is input using the barcode scanner 4 or by manual input using the keypad 8. For an item barcode, the MCU 23 searches the build-in barcode database 40 and the user defined custom barcode database 41 resided in the flash memory 31. The database in the flash memory is a table containing UPC code and human understandable descriptions of the item. Possible descriptions of item can be brand, manufacturer, title, name package method or size of the item. When a match is found, the barcode and the associated item descriptions are displayed on the dot matrix display 6. In an event a barcode item cannot be found in the build-in and user defined databases, the MCU 23 prompts the user to enter the item descriptions by using the build-in key pad panel 8. After the user confirmed the inputs are correct, and the user confirms to save the item to the shopping list, the MCU 23 adds the new item to the user defined database if it is not in the databases already, and then time and date stamped the item based on the internal real-time-clock 33 with back-up battery 34 before storing the item to the shopping list reside in the flash memory 31.

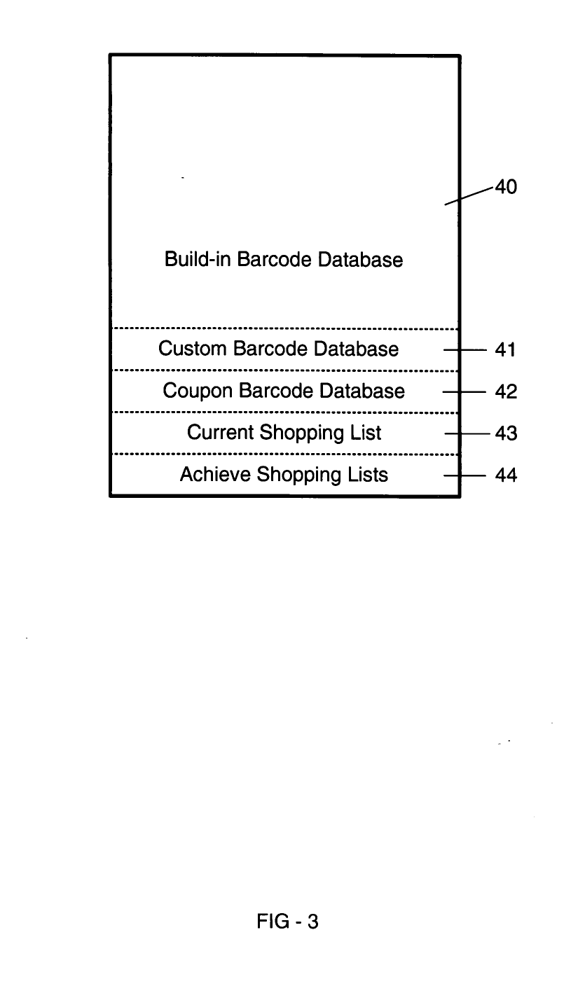

Referring to FIG. 3 and FIG. 9, for a coupon barcode, the MCU 23 prompts the user to enter the expiration date and a description of the coupon. After the user confirmed the inputs are correct, the coupon data is stored in the coupon barcode database 42. Once per day, the MCU sorts through the coupon database 42 to remove entries that are expired.

While there are products and software commercially available to manage shopping list, this invention is the only self-contained product without the need of personal computer or Personal Data Assistant. This apparatus comes with build-in display, key pad input device, integrated printer and build-in database. Together with the innovative human machine interface and integrated software execution define the uniqueness of this invention.

While certain novel combination of features of this invention have been shown and described and are pointed out in the annexed claims. The scope of this invention is certainly not limited to the above embodiments. It is understood that various omissions, modifications, substitutions and changes in the forms and details of the apparatus illustrated and can be made by those skilled in the art without departing in any way from the spirit of the present invention. For examples, the dot matrix LCD display and the key pad panel can be integrated with a touch screen monochrome or color LCD display and the thermal printer can be replaced by an impact type printer.

What is claim is:

1. An integrated electronic barcode shopping aid apparatus comprising:
a base unit housing big enough to integrate all the essential components;
a thermal printer with paper storage area to print out shopping lists and coupon list;
a display mounted in said unit;
a manual input device to allow user manually inputs barcodes and descriptions and to personalize the shopping aid system;
a data storage area to store the build-in product barcode database which associate barcodes with product name and descriptions;
at least one data storage area for user defined product barcode database;
at least one data storage area for user defined coupon barcode database;
a microcontroller based electronic system with software mounted in said base unit housing to compare the barcodes with the product name and descriptions, and to time stamped the input data, and to compile the shopping list, and to achieve old shopping list, and to organize coupons, and to display the status of the system, and to print the shopping lists or coupon list stored in the said data storage area, and to remind user of special days shopping;
a microcontroller based barcode reader separated from the said housing, to acquire barcode from inventory items or merchandise items or money saving coupons and to decode and to transmit the barcodes data to the base unit via electrical cable or optical cable or IR or RF radiation.

2. The apparatus of claim 1 has an external or internal voltage converter. The said voltage converter converts AC voltage from an electrical utility to a DC voltage. The said DC voltage is used to power all the circuitry in said integrated electronic shopping aid apparatus.

3. The apparatus of claim 1 further comprising light emitting diodes (LED) or other light emitting indicators to show the vital status of the apparatus. The vital status includes but not limited to input power, out-of-paper and system error.

4. The apparatus of claim 1 further comprising control buttons linked to said microcontroller to control the printing functions of the said apparatus directly.

5. The apparatus of claim 1 in which said barcode scanner comprises at least one LED or laser diode to illuminate the barcode, at least one optical detector to sense the dark and light bands of the barcodes, and a microcontroller to interpret and to translate the dark and light bands into human-readable forms. The optical detector can be photodiode, CMOS optical sensor or CCD optical sensor.

6. The apparatus of claim 1 wherein said software program includes means to differentiate item barcodes and coupon barcodes.

7. The apparatus of claim 1 wherein said software program includes means for comparing one of more database against the scanned barcode, to retrieve descriptions of the scanned barcode from one of the database, to compile the scanned items into a shopping list, to organize the scanned coupons based on the expiration date of the coupons, to cross reference valid coupons against the shopping list.

8. The apparatus of claim 1 in which said data storage area can be but not limited to Flash Memory, Random Access Memory (RAM), Read Only Memory (ROM), Electrical Erasable Programmable Read Only Memory (EEPROM), optical disc or any other electrical or magnetic or optical storage devices.

9. The apparatus of claim 1 in which said the output device can be a thermal printer, impact printer or various kinds of removable data storage devices, such as SD card or min-SD card or compact flash to storage the shopping list.
